(19) United States
(12) Patent Application Publication
(10) Pub. No.: US 2006/0165460 A1
(43) Pub. Date: Jul. 27, 2006

(54) Handheld printing device connectable to a mobile unit

(76) Inventor: Alex Breton, Enskede Gard (SE)

Correspondence Address: DICKSTEIN SHAPIRO MORIN & OSHINSKY LLP, 2101 L Street, NW, Washington, DC, 20037, US

(21) Appl. No.: 10/499,295

(22) PCT Filed: Nov. 22, 2002
(86) PCT No.: PCT/SE02/02147

§ 371 Date: Apr. 22, 2005

(30) Foreign Application Priority Data
Dec. 21, 2001 (SE) 0104384-3

(51) Int. Cl. B41J 3/36

(52) U.S. Cl. 400/88

(57) ABSTRACT

The present invention relates to a handheld printing device (1) having a print head for printing a printout on a printout surface. The handheld printing device (1) comprises an interface for mechanical and electrical connection to a handheld mobile unit (9) capable of communicating with other units for information retrieval. The entire unit, including the handheld mobile unit (9) and the connected handheld printing device (1) is manually steered over said printout surface with the aid of one or more positioning sensors disposed in the printing device 1 and co-operating with a micro controller circuit. Thereby information retrieved by the mobile unit, or stored therein, can be printed by said printing device (1). The invention also relates to a handheld mobile unit (9) connectable to said handheld printing device (1).

### FIELD OF THE INVENTION

The invention relates to a handheld printing device and a handheld mobile unit connectable to such a handheld printing device, of the kind apparent from the attached claims 1 and 11 respectively.

The invention thus relates to printing of information retrieved by a mobile unit, the printing being performed by a handheld printing device.

### BACKGROUND OF THE INVENTION

There is an ever increasing need and desire amongst people to be reachable wherever they are. In this increasing wireless communication trend, access to the Internet from mobile terminals is a popular feature. People want to be able to surf the Internet on the their journey to work, on the bus or in short, at all times and wherever they are.

A situation that may occur when surfing the Internet, is that the user wishes to print a web site, or parts of it, for example an address to a restaurant that the user has found when surfing the Web. It is today not feasible to perform such a printing process for a user moving around, since the smallest printers of today are not small enough to be an attractive option to a user. They are simply too big and clumsy to be brought along.

There are indeed handheld printing devices, see for example U.S. Pat. No. 5,927,872 or U.S. Pat. No. 6,233,368. These handheld printing devices can however not be used in order to print information retrieved elsewhere, for example from the Internet. These handheld printing devices are thus not an option for a user who wishes to be able to bring along a printer for printing information in the form of images and/or text, wherever he or she is.

Thus there exists a need to provide a handheld printing device that is connectable to a mobile unit, for example a cellular phone, for printing information retrieved by the mobile unit.

### SUMMARY OF THE INVENTION

An object of the present invention is to provide a handheld printing device including means for connection to a mobile unit, such as a mobile radio communication unit, or the like, in order to enable the printing of information retrieved by the mobile unit or stored therein.

This object is achieved, according to a first aspect of the invention, by a printing device as claimed in claim 1.

In accordance with one embodiment of the handheld printing device according to the present invention, the information retrieved is information from the Internet, which enables a user to surf the Internet and print a desired web site, irrespective of where the user is located.

In accordance with another embodiment, the handheld printing device includes a plug-in-unit for attachment to a mobile unit. This feature, i. e. the handheld printing device not being attached to the mobile unit in a permanent way, gives the user the choice of leaving the printing device at home if desired.

In accordance with yet another embodiment, the printing device uses the power source of the mobile unit, when attached to it, enabling the manufacture of even smaller printing devices.

In accordance with a further embodiment of the printing device, security measures are included in order to prohibit an unauthorised use of the printing device.

In accordance with a still further embodiment, the printing device includes circuitry for the transfer of information to a mobile unit. This feature makes it feasible to store information (images or text for example) in the printing device, transfer this information to the mobile unit, which in turn may pass it on elsewhere, for example to the Internet.

In accordance with still another embodiment of the handheld printing device, the handheld printing device includes an interface for reception of voice information that can be printed by the printing device. This voice control enables a variety of features. A user may for example dictate short words to be printed, which words may then be stored in a memory thereof.

In accordance with yet another embodiment of the handheld printing device, the handheld printing device includes an interface to a keyboard or some other input means, whereby information may be input by means of the keyboard and printed by the printing device.

According to a second aspect of the invention there is provided a handheld mobile unit including an interface for mechanical and electrical connection to a handheld printing device, as defined in claim 11.

Further objects and embodiments of the present invention will become evident from the following description.

The invention will now be explained further below, by way of examples, with reference to the accompanying drawings.

### BRIEF DESCRIPTION OF THE DRAWINGS

FIGS. 1a-d show different views of an embodiment of the handheld printing device according to the present invention, the FIGS. 1a and 1b being partially cut away for clarity.

FIGS. 2a-b show how a printing device according to the present invention is connectable to a mobile unit.

FIG. 3 shows a printing device according to the invention connected to a mobile unit.

### DETAILED DESCRIPTION OF PREFERRED EMBODIMENTS

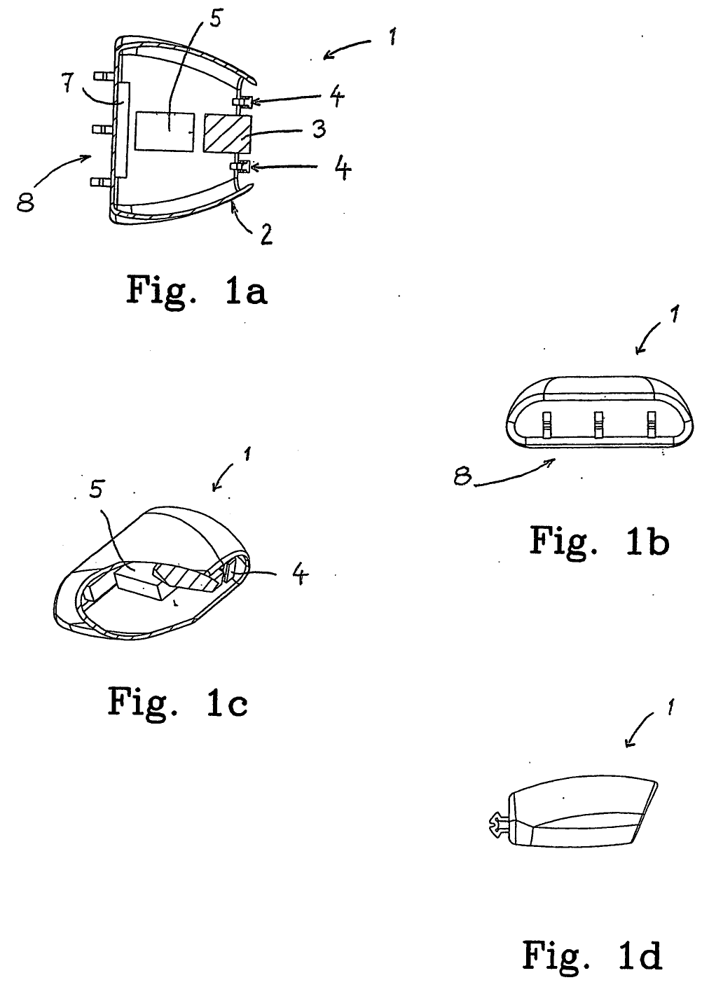

With reference to FIG. 1a, the integrated handheld printing device 1 comprises a housing 2, which can be made of for example plastic, metal or any other suitable material. A light material is preferred in order to reduce the weight, since the handheld printing device 1 is intended to be highly portable.

The printing device 1 also comprises a print head 3, which could be for example an ordinary ink jet printer, where several nozzles under the influence of computer controlled electrical signals eject tiny ink drops, which then build up a predetermined pattern. Alternatively, a bubble jet print head could be used or any other suitable print head. The housing 2 has an opening at one end where the print head 3 is situated in order to enable free flow of the ink onto a printout surface.

The printing device 1 further comprises sensors 4 for sensing the position of the print head 3. If optosensors are used, the characteristics of a printout surface can be sensed and thereby, with the aid of a microprocessor 5, a determination of the position of the print head 3, the speed, acceleration and direction and/or other parameters can be accomplished. In FIG. 1a the handheld printing device 1 is shown to include two sensors 4. However, one sensor 4 only is enough, since generally only linear movements need to be sensed. The sensors 4 are situated at the open end of the housing 2, where they are able to determine the current position of the print head 3.

A microprocessor 5 is also, as mentioned, included within the housing 2. The main task of the microprocessor 5 is to control the function of the printing head 3. The microprocessor 5 preferably includes a memory (not shown) for storing information retrieved by some means. The memory could also contain information a priori.

The printing device 1 also includes a power supply 7, e.g. an ordinary battery, for feeding the handheld printing device 1 with electric power. Alternatively, the handheld printing device 1 is fed from an adjacent device, a mobile unit for example, to which it is connected.

The handheld unit 1 is connectable to a mobile unit by means of an interface 8, which preferably includes mechanical coupling means as well as electrical contact means in order to enable the exchange of information with the mobile unit. The interface 8 is preferably a standard plug-in interface for connection to a mobile unit.

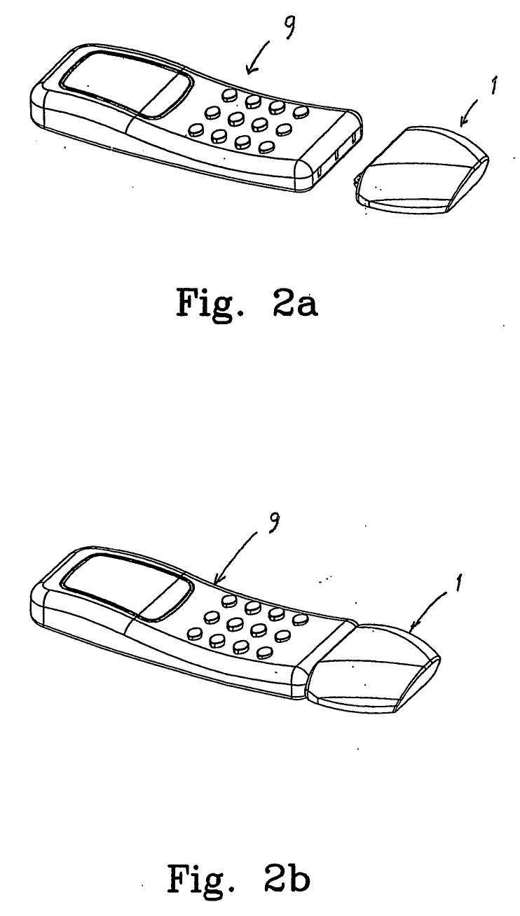

FIGS. 2a-b show how the handheld printing device 1 is connected to a mobile unit 9. As explained in connection with FIGS. 1a-d, the interface 8 to a mobile unit 9 includes means for both mechanical and electrical connection. As can be seen in FIGS. 2a-b, the handheld unit 1 is small and can thus conveniently be brought along and be used in many situations. A user just steers the entire combined handheld unit, consisting of the printing device 1 and the mobile unit 9, by hand over the surface to be printed on.

The handheld printing device 1 includes means for exchanging information with the mobile unit 9. The mobile unit 9 may, as is known in the art, retrieve information from many sources, for example the Internet, over a mobile communication network. A user may thus receive information by means of the mobile unit 9, connect the mobile unit 9 to a handheld printing device 1, and then print this information by means of the handheld printing device 1.

If the printing device 1 contains a memory, information stored therein can be transferred to the mobile unit 9 via the interface 8. The mobile unit 9 may in turn transmit this information over the mobile communications network (if the mobile unit 9 is a cellular phone) to a desired receiver. The handheld printing device 1 may be connectable to a computer or the like, by means of which the memory may be updated or altered in a convenient manner.

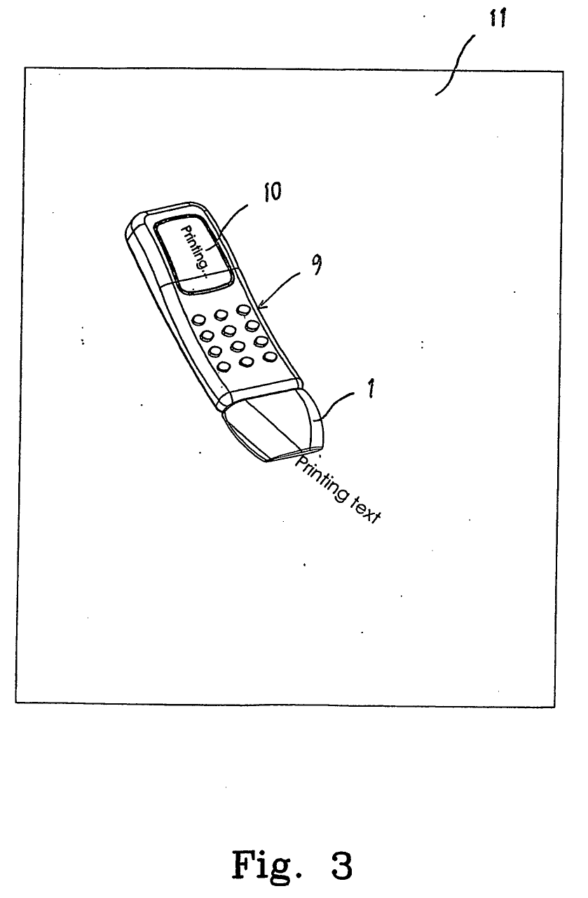

FIG. 3 shows the handheld printing device 1 connected to a mobile unit 9 and printing a text “printing text”. The mobile unit 9 typically includes a display 10, especially in case it is a cellular phone. The mobile unit 9 and the handheld printing device 1 may exchange information, as explained above. This, together with the display 10, makes it possible to show the information to be printed, or parts thereof, before or even during the printing process. An image of the whole printout page may be shown on the display 10, and a dynamic rectangle may visualise the movements of the print head 3 as the user moves the handheld printing device 1 over a printout surface 11. This enables the user to see a dynamic image of the printout in progress (a portion of the picture to be printed). The dynamic image corresponds to the picture in progress on the printing surface 11 both as regards position and scale.

In accordance with a further embodiment (not shown), the handheld printing device 1 is provided with a corresponding display 10.

In accordance with another embodiment, the handheld printing device 1 includes means for preventing unauthorised use. This could for example consist in connecting the handheld unit 1 to only a certain mobile unit 9 (for example by means of the mobile equipment identity number, IMEI), thereby disabling the use of the handheld printing device 1 with any other mobile unit 8. Consequently, if the mobile unit 9 is blocked, the handheld printing device 1 is not either usable.

According to another embodiment, the handheld unit 1 is provided with an interface for voice control or printing of voice information. This can be seen as an alternative way to provide the handheld unit 1 with information to be printed.

A still further way to feed the handheld unit 1 with information is to provide it with an interface for connection to a keyboard or some other input means, by means of which the user may input information to be printed. The keyboard of the mobile unit 9 to which the printing device 1 is connected, may of course serve as such information input means.

The handheld printing device 1 and the handheld mobile unit may in an alternative embodiment be an all-in-one device, i.e. not constituting two separable parts.

The mobile unit 9, to which the handheld printing device 1 is connectable, need not be a mobile phone, as shown in FIGS. 2a-b and 3. The mobile unit 9 could just as well be, for example, a PDA (Personal Digital Assistant) (not shown). A user may in that case retrieve information from a memory of the PDA and then print it when desired.

1. A handheld printing device (1) having a print head (3) for printing on a printout surface (11) characterised in that the printing device (1) comprises an interface (8) for mechanical and electrical connection of the printing device (1) to A handheld mobile unit (9) having means for information retrieval, and in that the entire unit, including the handheld mobile unit (9) and the connected printing device (1) with the print head (3), is manually steerable over said printout surface (11) with the aid of A micro controller circuit (5) being electrically connected to said handheld mobile unit (9), whereby information retrieved by the handheld mobile unit (9), or stored therein, can be printed by said printing device (1).

2. Printing device as claimed in claim 1, characterised in that said micro controller circuit (5) is connected to at least one positioning sensor (4) disposed in the printing device (1).

3. Printing device as claimed in claim 1, characterised in that said mobile unit (9) is a mobile radio communication unit.

4. Printing device as claimed in claim 3, characterised in that the mobile radio communication unit retrieves information from the internet, which information is printed by said printing device (1).

5. Printing device as claimed in claim 1, characterised in that the printing device (1) includes a plug-in-unit for attachment of the printing device (1) to the mobile unit (9).

6. Printing device as claimed in claim 5, characterised in that the printing device (1), when plugged in, utilises a power source of the mobile unit (9).

7. Printing device as claimed in claim 1, characterised in that the printing device (1) includes a security measure comprising the printing device (1) being usable only with an authorised mobile unit (9).

8. Printing device as claimed in claim 1, characterised in that the printing device (1) includes circuitry for transfer of information to the mobile unit (9).

9. Printing device as claimed in claim 1, characterised in that the printing device (1) comprises an interface for reception of voice information that can be printed by the printing device (1).

10. Printing device as claimed in claim 1, characterised in that the printing device (1) comprises an interface for reception of information input by a keyboard, which information can be printed by the printing device (1).

11. A handheld mobile unit for information retrieval, characterised in that the handheld mobile unit (9) comprises an interface (8) for mechanical and electrical connection to a handheld printing device (1) as defined in claim 1.

12. Handheld mobile unit as claimed in claim 11, characterised in that the handheld mobile unit (9) is capable of communicating with other units for information retrieval.

13. Handheld mobile unit as claimed in claim 11, characterised in that the handheld mobile unit (9) comprises circuitry for exchanging information with the printing device (1).

14. Handheld mobile unit as claimed in claim 13, characterised in that the handheld mobile unit (9) is capable of showing, on a display (10) of the mobile unit, at each moment a portion of said printout corresponding in position to the printout in progress.

15. Handheld mobile unit as claimed in claim 14, characterised in that said portion of said printout is shown in a window on said display (10), said portion being the portion located underneath the print head (3) and its close vicinity.

16. Handheld mobile unit as claimed in claim 14, characterised in that a whole printout page (11) is represented on the display (10), and that a dynamic rectangle visualising the print head (3) moves over the display (10) as the user moves the printing device (1) over said printout page (11).

17. Handheld mobile unit as claimed in claim 11, characterised in that the handheld mobile unit (9) comprises an interface for reception of voice information that can be printed by the printing device (1).

18. Handheld mobile unit as claimed in claim 11, characterised in that the handheld mobile unit (9) comprises an interface for reception of information input by a keyboard, which information can be printed by the printing device (1).

19. Handheld mobile unit as claimed in claim 11, characterised in that said handheld mobile unit (9) is a mobile radio communication unit.

20. Handheld mobile unit as claimed in claim 11, characterised in that said handheld mobile unit (9) is a Personal Digital Assistant (PDA).

21. Handheld mobile unit as claimed in claim 11, characterised in that the mobile unit (9) and the printing device (1) are combined into an all-in-one device.

22. Handheld mobile unit as claimed in claim 11, characterised in that the mobile unit (9) and the printing device (1) form two separable parts.
